(19) United States
(12) Patent Application Publication
(10) Pub. No.: US 2024/0019171 A1
(43) Pub. Date: Jan. 18, 2024

(54) Electric Heating Device and Method of Manufacturing the Same

(71) Applicant: Eberspächer catem GmbH & Co. KG, Herxheim (DE)

(72) Inventors: Patrick Werner, Neuhofen (DE); Karsten Bolz, Erlenbach (DE); Jan-Michael Feustel, Bodelwitz (DE)

(21) Appl. No.: 18/221,710

(22) Filed: Jul. 13, 2023

(30) Foreign Application Priority Data
Jul. 14, 2022 (DE) 10 2022 117 647.9

(51) Int. Cl. F24H 1/10

(52) U.S. Cl. CPC F24H 1/101

(57) ABSTRACT

An electric heating device has a housing with inlet and outlet openings for a fluid to be heated. The housing has a circulation chamber for passing the fluid to be heated through the housing and a connection chamber for the electrical connection of at least one PTC heating assembly. The PTC heating assembly comprises at least one PTC element strip conductors which energize the PTC element with different polarity and which are heat-conductively coupled to at least one surface of the housing delimiting the circulation chamber. Measures are taken to disturb a laminar boundary layer of the fluid to be heated on at least one of the heat-emitting surfaces. A method is provided for processing at least one heat-emitting surface formed by the housing to provide a structure that disturbs the laminar boundary layer of the fluid to be heated.

### BACKGROUND OF THE INVENTION

### 1. Field of the Invention

The present invention relates to an electric heating device with a heater housing having inlet and outlet openings for a fluid to be heated, the heater housing having a circulation chamber for passing the fluid to be heated through the heater housing and a connection chamber for electrical connection of at least one electric heating assembly that is heat-conductively coupled to a heat emitting surface delimiting the circulation chamber.

### 2. Background of the Invention

Such an electric heating device is known, for example, from EP 1 872 986 A1 or EP 2 797 381 A1.

This previously known electric heating device has a multi-part heater housing, which comprises a circulation chamber for passing the fluid to be heated through the heater housing and a connection chamber for the electrical connection of at least one PTC heating assembly. The heater housing has inlet and outlet openings for introducing and discharging the fluid to be heated into and out of the housing, respectively. Between the circulation chamber and the connection chamber there is a partition wall from which, in the aforementioned prior art, receiving pockets protrude into which PTC heating assemblies can be inserted on the connection side. These receiving pockets protrude into the circulation chamber in the manner of heating fins. In this embodiment, the circulation chamber is completely fluidically separated from the connection chamber by the housing. The connection chamber usually also has a control device for the PTC heating assemblies which are electrically connected inside the connection chamber and may also be grouped there to form heating circuits.

In another prior art according to EP 2 884 817 A1, the heating fins are formed by plug elements which are inserted in a sealing manner in plug element receptacles which are recessed in the partition wall, wherein contact tongues of the PTC heating assemblies are extended and transferred through the partition wall into the connection chamber.

The previously mentioned features of the prior art may also be essential to the present invention.

The electric heating device according to the present invention has—like the prior art—at least one electric heating element like a PTC element, which PTC element is a usually cuboid-shaped ceramic brick provided with a metallization on opposite sides for introducing the power current. This PTC element is connected to different polarity via strip conductors. Both the strip conductors and the PTC element are components of the PTC heating assembly.

The PTC element is self-regulating. In any case, beyond a critical temperature, which is also called the Curie temperature, the electrical resistance of the PTC element usually increases exponentially with the temperature. Thus, the power consumption of the PTC element is limited by the actual temperature of the PTC element. These self-regulating properties of the PTC element indeed usually prevent overheating of the electric heating device, which is important for the present invention, as the same in particular is an electric heating device used in a motor vehicle. However, the self-regulating properties also require very good heat conduction between the PTC element and the fluid to be heated. This is because such good heat conductivity ensures good dissipation of the heat generated. Thus, the PTC element—compared to a configuration with poor heat conductivity—is operated at a lower temperature and thus with higher efficiency.

With EP 1 872 986 A1 it is proposed to brace the PTC element in the receiving pocket by means of a wedge in order to thus in any case achieve an intimate heat-conducting abutment between the PTC element and the inner surfaces of the receiving pocket. In EP 2 884 817 A1, the walls of the receiving pocket can essentially be dispensed with for passing the heat through. The PTC heating assembly is inserted into the partition wall. In this way, for example, heat dissipation can be achieved by means of an insulating ceramic layer which is received in a sealed manner in a frame of the PTC heating assembly and which can abut directly against the PTC element in a heat-conducting manner; cf. DE 10 2019 204 401 A1. In this prior art, the introduction of the power current does not take place as usual via a main side surface of the PTC element, which has the largest spatial extension, but via an end face of the cuboid PTC element, which connects the two main side surfaces with each other. This also provides a very direct path for the heat passage.

The above examples show that there has been no lack of efforts to optimize the heat extraction from the PTC element and introduction into the medium to be heated. Nevertheless, the present invention still sees scope for improvement.

### SUMMARY

The present invention aims to provide an electric heating device of the kind mentioned introductorily, which has a very good efficiency.

In order to solve this problem, the present invention proposes an electric heating device with inlet and outlet openings for a fluid to be heated. The device includes a housing that has a circulation chamber for passing the fluid to be heated through the heater housing and a connection chamber for the electrical connection of at least one electric heating assembly that is heat-conductively coupled to at least one surface delimiting the circulation chamber. The electric heating assembly can comprise a PTC element and/or an electric resistance wire.

The electric heating device comprises means which disturb a laminar boundary layer of the fluid to be heated on at least one of the heat-emitting surfaces. The means ensure micro swirling or micro turbulence at the surface. This flow behavior improves the heat transfer coefficient at the heat-emitting surface under otherwise identical flow conditions and/or with otherwise identical structural configuration. This is due to the fact that laminar flow usually has no velocity components that extend perpendicular to the heat-emitting surface.

The means are provided by measures that serve to increase the roughness of the heat-emitting surface. This roughness can be produced, for example, by mechanical finishing. This roughness can also be provided by the characteristics of the mold used for producing a cast component.

Thus, it is possible to enlarge the surface by blasting, for example sand-blasting or shot-blasting, or mechanical processing.

The heat-emitting surface is typically a surface of a housing that supports electric heating assembly, in particular the PTC element and strip conductors in an electrically insulated manner. The heat-emitting surface is typically one of the main side surfaces of such a housing.

The main side surface can be formed by a ceramic plate as disclosed in EP 3 416 456 A1. In this case, the PTC element and/or the strip conductor abuts against the ceramic plate on the inside. In the course of the manufacturing process, the ceramic plate may be provided with irregularities that interfere with the formation of a laminar boundary layer of the fluid to be heated on the corresponding surface. This three-dimensional surface structure can be formed, for example, during sintering of the ceramic material.

The housing may be made of metal and form an accommodation space for the at least one PTC element and the strip conductors. In addition, an insulating layer can be provided in the accommodation space. However, electrical insulation can also be formed by a corresponding coating on the inside of the housing.

The corresponding housing can be formed by joining sheet metal segments which may have been previously formed, if necessary. In this case, before joining the sheet metal segments and/or afterwards, machining can be carried out in particular on the areas of the sheet metal segments forming the main side surfaces with the aim of providing a three-dimensional surface structure at least there which interferes with the formation of a laminar flow. This three-dimensional surface structure can be produced during forming of the metal.

For example, it is known from DE 10 2019 205 848 A1 to manufacture a housing from metal by thermoforming. In the course of this forming process, ribs can be formed on the housing, for example. The tool surfaces used in thermoforming have a correspondingly adapted negative shape for this purpose. For example, the die used for thermoforming can be provided with regular corrugations and valleys, which result in a corresponding surface configuration on the side of the housing during thermoforming.

The three-dimensional surface configuration can also be produced after the components configuring the heating cell have been introduced into the housing. Thus, according to a possible further configuration of the present invention, at least the PTC element and the strip conductors are introduced through an opening into the housing, which may already be closed on the lower side. By subsequent forming, preferably not only the three-dimensional surface structure is formed on the outside of the housing. Rather, the metal of the housing is driven during such a forming process, causing the two main side surfaces to approach each other. In this way, the main side surfaces are forced against the PTC element, at least in sections. Usually, at least one, typically both, main side surfaces of the housing are processed in a corresponding manner Preferably, each of the main side surfaces is deformed separately and, on the one hand, is abutted against the PTC element in sections, typically in a planar manner. This abutment does not necessarily have to take place directly against the PTC element. The abutment may also be made with the strip conductor and/or an insulating layer being interposed. In the process of forming the three-dimensional surface structure, the housing as a whole also can be formed so that the opposing main side surfaces of the housing are brought closer together and applied against the PTC element with good heat-conducting properties.

In the course of processing, the surface can be roughened, for example, it can have a toothed surface structure and be knurled. A roughness of between 0.030 and 0.190 mm, typically between 0.05 and 0.10 mm, has proven to be suitable, wherein this dimension is to be understood as the roughness depth Rz and indicates the height distance between the highest roughness peak and the lowest roughness valley. The roughness Ra can be between 0.004 and 0.025 mm, more typically between 0.006 and 0.012 mm. The balls should have a diameter of between 0.6 and 1.8 mm. The same applies to grains, wherein a dimension corresponding to the diameter applies to irregular grains.

A correlation between the measured heat transfer at the heat-emitting surface and the three-dimensional surface structure has shown the following parameters to be typical, which can be used individually or in combination:

Insofar as troughs are provided on the surface, in particular by blasting, about 3.5 to 23 troughs per square millimeter of a previously flat main side surface should be provided. Between 7 and 11 troughs per square millimeter are typical. Between 2 and 12 troughs should have a common ridgeline with a central trough. Between 4 and 7 troughs adjacent in this way are typical. The distance between such a central trough and an immediately adjacent trough should be between 0.16 mm and 1.1 mm, more typically between 0.3 mm and 0.5 mm Each trough may have a surface projected into the plane of the main side surface of between 0.04 and 0.28 square millimeters, wherein a range for the projected surface of between 0.08 and 0.18 square millimeters is typical.

The troughs may be round. The aspect ratio between the maximum and minimum diameter of the trough may be between 1 and 6.5. An elongated orientation transverse to the main flow direction of the fluid to be heated is harmless. Since such an orientation cannot be set reliably during economically performed blasting, the aspect ratio should typically be between 1 and 3. The surface of the individual trough is enlarged by 30% to 180%, more typically by 50% to 100%, compared to the surface of a continuous flat surface in which the trough is formed.

In a knurl, for example, serrated projections may extend transversely to the flow direction, wherein the tips of adjacent serrations may have a distance of between 1.5 and 1.7 mm A useful roughness of a knurl is between 0.4 and 0.7 mm. Due to ribs extending transversely to the main flow direction of the fluid and valleys between the ribs, the configuration of a laminar flow along the heat-emitting surface can be disturbed. Moreover, due to the upper surface structure, an enlargement of the heat-emitting surface by about 17% can be achieved compared to a flat/planar surface.

The above-mentioned finishing and roughnesses apply to mold surfaces for molding heat-emitting surfaces, for example by impact extrusion, bar extrusion or casting, in particular of metallic materials, especially aluminum or an aluminum alloy for producing a heat-emitting surface of a heating device. With these surfaces, the enlarged surface structure is produced by the Surface configuration of a used for producing the heat-emitting surface of the heating device. However, the above-mentioned finishing and roughness also apply to the heat-emitting surface of the heating device.

According to the present invention, the heat transfer coefficient α is increased by at least 150% compared to a flat base surface without a separate surface structure adapted with a view to preventing laminar boundary layer flows.

The heat-emitting surface may have a surface area that is at least 15% larger than the base surface. In the case of a planar base surface, this is calculated from the square of the height to the width. It is understood that the base surface must be exposed to the flow of the fluid to be heated. The means enlarge the surface of the corresponding area. The resulting surface is at least 10%, and more typically 15%, larger than the base surface calculated in the above manner.

The electric heating device of the present invention may be a water heater for use in a motor vehicle.

The heat-emitting surface may be the surface of a heating fin which protrudes into the circulation chamber in the manner described above. However, the heat-emitting surface modified according to the invention can also be the surface of the housing which surrounds or predefines the circulation chamber, but does not configure the heating fin.

It is understood that the structures disturbing the laminar flow have projections or depressions extending transversely to the main flow direction. The main flow direction is the direction through which the flow passes within the circulation chamber between the inlet opening and the outlet opening. Corresponding disturbances to the smooth surface geometry in the prior art can be formed by ribs, webs, projections or even grooves, which configure flat surface sections between them, for example. The means can also be formed by application to the surface, for example by plasma spraying and/or welding or soldering of irregular structures.

Practical tests have shown that due to the improved heat transfer coefficient, the PTC element can be operated more effectively. The amount of heat transferred from the PTC element to the medium to be heated with otherwise identical boundary conditions is increased by 3-5% compared to conventional configurations. Hence, an improved cooling of the PTC element during operation is achieved.

### BRIEF DESCRIPTION OF THE DRAWINGS

Further details and advantages of the present invention will be apparent from the following description of an embodiment in conjunction with the drawing. Therein:

FIG. 1 shows a perspective side view of an embodiment of an electric heating device;

FIG. 2 shows a perspective side view of the embodiment according to FIG. 1 after connection of the PTC heating elements;

FIG. 3 shows a perspective exploded view of the PTC heating assembly of the electric heating device shown in FIGS. 1 and 2;

FIG. 4 shows a perspective view of the roughness of a main side surface of the housing before blasting;

FIG. 5 shows a perspective view of the roughness of the main side surface of the housing after blasting;

FIG. 6 shows the roughness profile along the line VI-VI according to FIG. 4 and

FIG. 7 shows the roughness profile along the line VII-VII according to FIG. 5.

### DETAILED DESCRIPTION

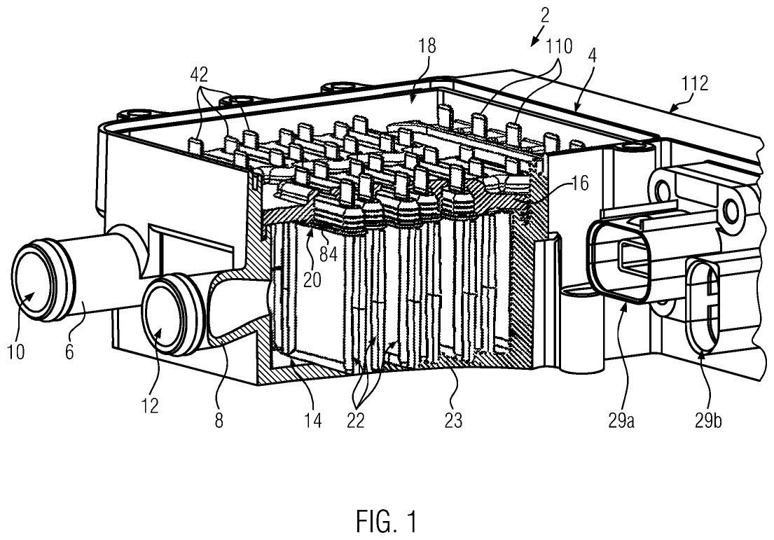

FIG. 1 shows a perspective top view of a heater housing, characterized by reference sign 2, of an electric heating device configured as a water heater. The heater housing 2 has a housing tub element 4 made of plastic. The heater housing 2 forms an inlet port 6 and an outlet port 8, which are presently configured in one piece on the housing tub element 4. The ports 6 are configured as hose connection pieces and form an inlet opening 10 and an outlet opening 12, respectively, to a circulation chamber characterized by reference 14.

The circulation chamber 14 is separated from and sealed off from a connection chamber 18 by a partition wall 16 made of plastic. The partition wall 16 forms female plug element receptacles 20 for PTC heating assemblies 22, which are inserted in a sealing manner into the female plug element receptacles 20 and are supported on a bottom 23 of the housing tub element 4.

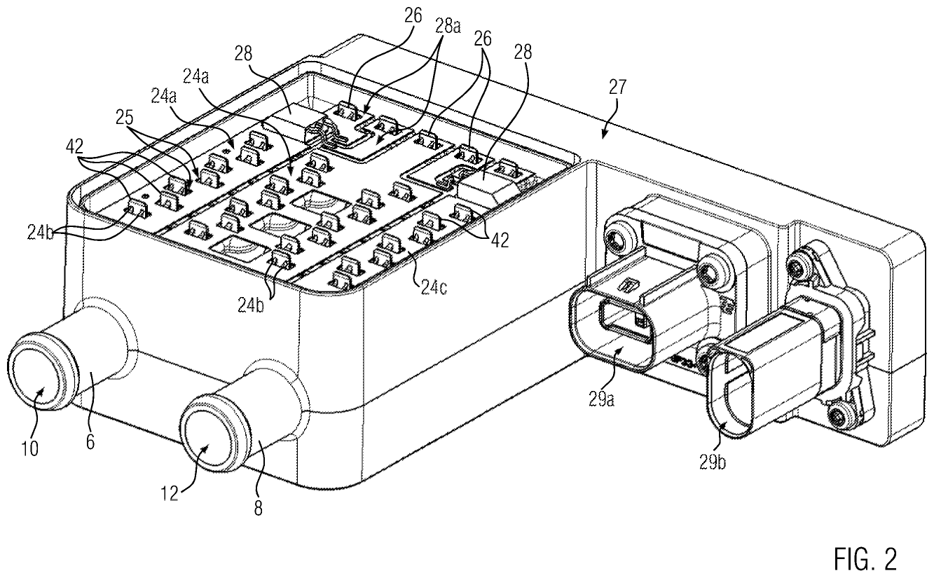

FIG. 2 illustrates the electrical connection of the PTC heating assembly 22. For the electrical connection, metal sheets are provided in the connection chamber 18 as busbars 24a, 24b, 24c, which have contact projections 24d formed by punching and bending, which abut against and make contact with contact tongues 42, explained in more detail below, under elastic pretension. The contact projections 24d project into receiving openings 25, which are recessed in the sheet metal strips of the busbars 24a, 24b, 24c. In the same way, terminal tongues characterized by reference sign 26 are connected, which are in contact with an equipped printed circuit board, which is accommodated in a control housing 27. In this context, the connection of the busbar 24b is made directly via the connection tongue 26, whereas the connection of the busbars 24a, 24b is made via a power transistor 28, which is contacted by stamped lead wires 28a, which are electrically connected to the associated connection tongues 26.

The reference signs 29a and 29b characterize connector housings, on the one hand, for the power current and, on the other hand, for control signals processed in a control device provided within the control housing 27 in order to switch the power current introduced via the connector housing 29a to the various busbars, each of which is formed by one of the busbars 24a through c.

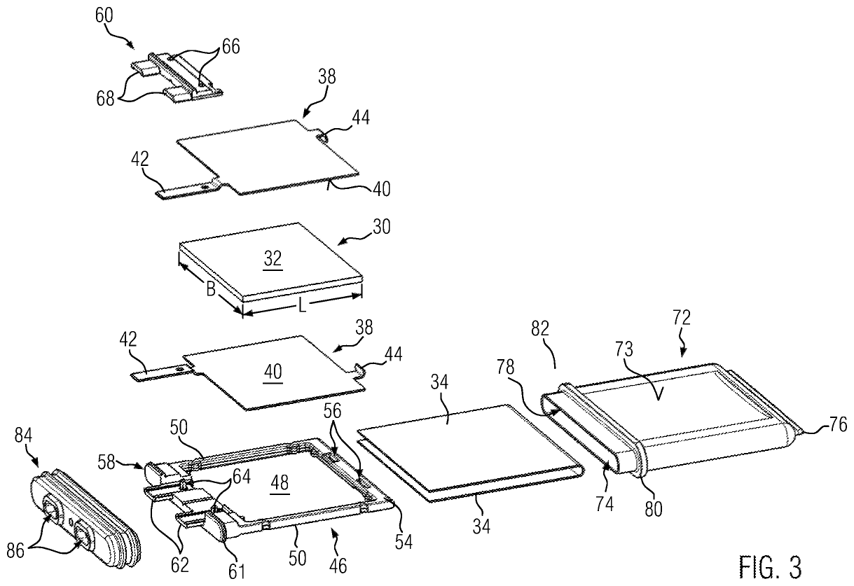

FIG. 3 shows details of the PTC heating assembly 22, which in this case has only one PTC element 30, which is covered on its opposite main side surfaces 32 with an insulating layer 34. The insulating layers 34 are formed by a plastic film, for example of Kapton. The PTC element 30 is configured as a platelet with a width B or a length L that is greater by a factor of at least 10 than a thickness corresponding to the distance between the two main side surfaces 32.

On opposite main side surfaces 32, contact sheets 38 are provided in each case, which can be bonded to the PTC element 30 and thereby electrically conductively bonded to a surface metallization of the PTC element 30, which can be applied as a layer to the ceramic PTC element 30 by means of PVD or CVD. The contact sheets 38 may also be merely applied to the PTC element 30. Each contact plate 38 forms a contact surface 40, which abuts against the main side surface 32 of the PTC element 30 in an electrically conductive manner, a contact tongue 42 protruding beyond the PTC element 30 on one side and a latching tongue 44 protruding from the opposite side, hereinafter referred to as the lower side. In the present case, the contact surface 40 is provided congruently with the main side surface 32 of the PTC element 30. The insulating layer 34 lies on the contact plate 38 on the side facing away from the PTC element 30 and covers the same.

The PTC element 30 is accommodated in a frame 46, which comprises a frame opening 48 for this purpose, which is bounded by longitudinal beams 50 and cross beams 52, 54. The lower cross beam 54 has two locking openings 56 for receiving the latching tongues 44. The upper cross beam 52 is configured integrally with a pass-through element base 58 which, together with a pass-through segment cover 60, forms a kind of stopper which is surmounted by a stop collar 61. This stop collar 61 is surmounted by half-shells 62 formed by the frame 46, from which pins 64 protrude. Corresponding to this, the pass-through segment cover 60 has bores 66 and half-shells 68 aligned with these.

For assembly, one of the contact sheets 38 is first inserted with its contact tongue 42 into the half shell 62. The pin 64 is passed through a bore recessed in the contact tongue 42. The latching tongue 44 of the contact sheet 38 is inserted into the associated locking opening 56. Connected in this way, the frame 46 has a base formed by the contact sheet 38, onto which the PTC element 30 is placed. Thereafter, the further contact sheet 38 is inserted into the other of the two half-shells 62 in the manner previously described and placed on the main side surface 32 of the PTC element 30.

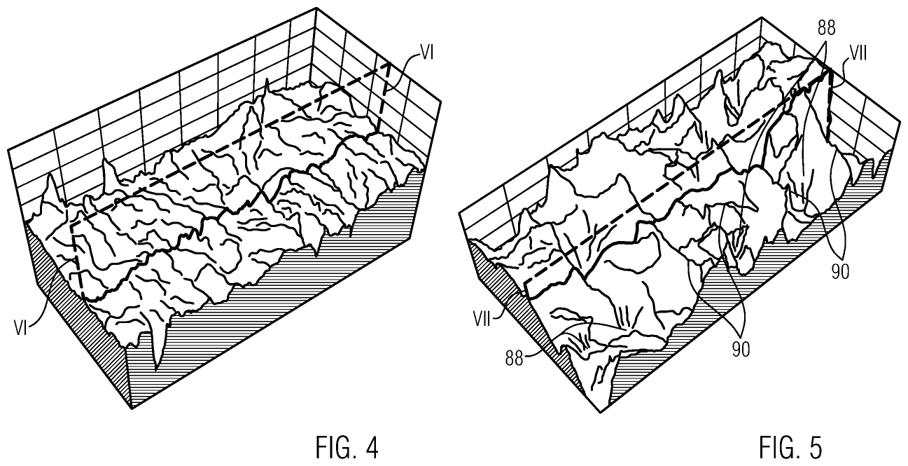

Thereafter, the pass-through segment cover 60 is applied so that the pins 64 are inserted into the bores 66 and the half-shells 68 of the cover 60 complete the half-shells 62 of the base 58. Thereafter, the respective contact tongues 42 are received in an insulating manner in a pass-through channel 70 formed by the half-shells 62, 68, respectively, and are extended beyond the frame 46 (compare FIG. 4). The pins 64 may thereafter be heat caulked to captively connect the base 58 and cover 60 to each other.

The thus produced structural unit is covered with the insulating layer 34. For this purpose, the plastic film forming the insulating layer 34 is folded around the lower cross beam 54 at the lower end of the frame to form parallel legs, each of which is formed by the uniform film and forms the insulating layers 34.

The thus produced unit is inserted into a housing 72 which forms, on opposite sides, main side surfaces 73 which serve to extract the heat generated by the PTC element 30 and to heat the fluid in the circulation chamber 14. The housing 72 is made of sheet metal and is formed by thermoforming and is provided with a single opening 74, wherein the area of the housing 72 opposite to the opening 74 is closed and is provided with a retaining rib 76 which cooperates in a receiving groove recessed on the bottom 23 of the heater housing 2 for positioning the PTC heating assemblies 22 in the heater housing 2.

The pre-assembled unit is inserted through the opening 74 into an accommodation space 78 of the housing 72. At the end of the insertion movement, the stop collar 61 strikes against the edge of the opening 74, whereby the installation position of the frame 46 and thus of the components of the PTC heating assembly 22 held by and placed around the frame 46 is predetermined.

Below the opening 74, the housing 72 forms a retaining rim 80 that extends around the housing 72 parallel to the edge of the opening 74 and forms a collar 82 between itself and the opening 74 which forms a contact surface for a sealing element 84. The sealing element 84 is formed of a soft elastic plastic, for example TPE or silicone, and has passage openings 86 for the interconnected half-shells, 62, 68. The sealing element 84 may be manufactured separately and joined to the frame 46 and the housing 72. Alternatively, it is also possible to join the sealing element 84 to the frame 46 and the thermoformed part 72 by overmolding.

FIGS. 4 and 5 illustrate the roughness of the main side surface 73 of the housing. FIG. 4 shows the roughness before machining to modify the surface. FIG. 5 illustrates the three-dimensional surface structure obtained by shot blasting with 1.6 mm wire grit. The scale shown between the two Figures illustrates the roughness profile.

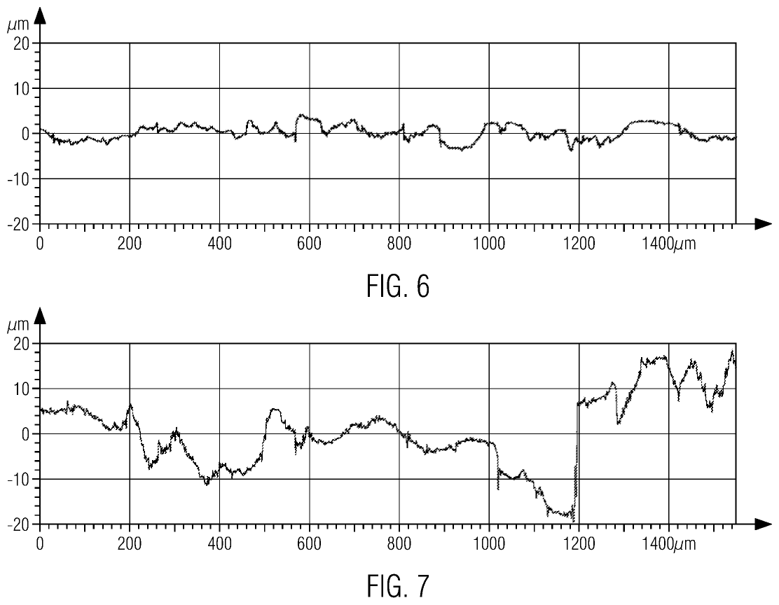

By blasting, a plurality of troughs 88 are introduced into the main side surface 73. The boundary between two troughs 88 defines a ridge line 90. Obviously, the surface is considerably enlarged due to the blasting in FIG. 5, as can be seen from the roughness profile in FIG. 7 and in particular from the comparison between FIG. 7, which shows the roughness profile after blasting, and FIG. 6, which shows the roughness profile before blasting.

The blasting may be carried out in such a way that the housing 72 is also plastically deformed as a whole by the blasted bodies, so that the main side surfaces 73 are plastically forced towards each other. This results in a remaining well heat-conducting contact of the PTC element 30 with the contact sheets 38 and the insulating layer 34 interposed against the housing 72. By means of adapted process conditions, the loading of the housing 72 can be set in such a way that the PTC element 30 is neither locally nor overall overstressed with the consequence that the PTC element breaks. Instead, the metallic material of the housing 72 is driven successively in the direction of the PTC element, wherein attention is paid to a uniform advance so that the opposite main side surfaces of the housing are approached uniformly however with low advance and are applied flat against the PTC element with good heat conduction.

1. An electric heating device comprising:
a heater housing having inlet and outlet openings for a fluid to be heated, wherein the heater housing has a circulation chamber for passing the fluid to be heated through the heater housing and a connection chamber for electrical connection of at least one electric heating assembly that is heat-conductively coupled to a heat emitting surface delimiting the circulation chamber; and
means for disturbing a laminar boundary layer of the fluid to be heated on the heat-emitting surface.

2. The electric heating device according to claim 1, wherein the heat-emitting surface is roughened.

3. The electric heating device according to claim 1, wherein the heat-emitting surface is mechanically reworked to increase roughness.

4. The electric heating device according to claim 1, wherein the heat-emitting surface has a surface area which is enlarged by at least 10% compared to a base area thereof.

5. The electric heating device according to claim 1, wherein the electric heating assembly is a PTC heating assembly comprising at least one PTC element and strip conductors which are conductively connected to the PTC element and which are configured to energize the PTC element with different polarity strip conductors.

6. The electric heating device according to claim 5, wherein the PTC heating assembly has a housing in which the at least one PTC element and the strip conductors are supported in an electrically insulated manner and which is surmounted on one side by contact tongues that are electrically coupled to the strip conductors, wherein a heat-emitting surface formed by the housing has the means for disturbing a laminar boundary layer of the fluid to be heated.

7. The electric heating device according to claim 6, wherein the housing of the PTC assembly is made of metal and is configured with an accommodation space for the at least one PTC element and the strip conductors, and wherein at least heat-emitting main side surfaces of the housing of the PTC assembly extend parallel to main side surfaces of the at least one PTC element and have a three-dimensional surface structure.

8. A method of manufacturing an electric heating device with a heater housing having inlet and outlet openings for a fluid to be heated, which heater housing comprises a circulation chamber for passing the fluid to be heated through the heater housing and a connection chamber for the electrical connection of at least one electric heating assembly, which electric heating assembly is heat-conductively coupled a heat emitting surface delimiting the circulation chamber, the method comprising:
processing the at least one heat-emitting surface to form means for disturbing a laminar boundary layer of the fluid to be heated.

9. The method according to claim 8, wherein the processing comprises forming a three-dimensional surface structure when forming the housing or a part thereof.

10. The method according to claim 8, wherein the processing includes deforming the heat emitting surface is surface after the housing has been formed to configure a three-dimensional surface structure.

11. The method according to claim 10, wherein the processing comprises surface-machining the heat emitting surface to form a three-dimensional surface structure after the electric heating element has been introduced into the housing, and wherein, in the course of this surface-machining, the surface is forced against the electric heating element, at least in sections thereof.

12. An electric heating device comprising:
a heater housing having inlet and outlet openings for a fluid to be heated, wherein the heater housing has a circulation chamber for passing the fluid to be heated through the heater housing and a connection chamber for electrical connection of at least one electric heating assembly that is heat-conductively coupled to a heat emitting surface delimiting the circulation chamber, wherein the heat emitting surface is configured to disturb a laminar boundary layer of the fluid to be heated on the heat-emitting surface.

13. The electric heating device according to claim 12, wherein the heat-emitting surface is roughened.

14. The electric heating device according to claim 13, wherein the heat-emitting surface is mechanically reworked to increase roughness.

15. The electric heating device according to claim 12, wherein the heat-emitting surface has a surface area which is enlarged by at least 10% compared to a base area thereof.
